(19) United States
(12) Patent Application Publication
(10) Pub. No.: US 2023/0162897 A1
(43) Pub. Date: May 25, 2023

(54) MAGNET MATERIAL AND PERMANENT MAGNET

(71) Applicants: KABUSHIKI KAISHA TOSHIBA, Tokyo (JP); TOHOKU UNIVERSITY, Sendai-shi (JP)

(72) Inventors: Shinya Sakurada, Saitama Saitama (JP); Satoshi Sugimoto, Sendai Miyagi (JP); Masashi Matsuura, Sendai Miyagi (JP)

(21) Appl. No.: 17/897,265

(22) Filed: Aug. 29, 2022

(30) Foreign Application Priority Data
Nov. 22, 2021 (JP) 2021-189389

(51) Int. Cl. H01F 1/055; C22C 38/12; C22C 38/10; C22C 38/00

(52) U.S. Cl. CPC H01F 1/055; C22C 38/12; C22C 38/10; C22C 38/005; C22C 2202/02

(57) ABSTRACT

A magnet material is represented by a composition formula 1: RₓNb_{y}BₓM_{100x-y-z}, R is at least one element selected from the group consisting of rare-earth elements, M is at least one element selected from the group consisting of Fe and Co, x is a number satisfying 4≤x≤10 atomic %, y is a number satisfying 0.1≤y≤8 atomic %, and z is a number satisfying 0.1≤z≤12 atomic %. The magnet material includes: a main phase having a TbCu₇ crystal phase; and a grain boundary phase. The magnet material satisfies a relation of n_{Nb2}/n_{Nb1}>5, where n_{Nb1} is an average Nb concentration in the TbCu₇ crystal phase and n_{Nb2} is a maximum Nb concentration in the grain boundary phase.

### CROSS-REFERENCE TO RELATED APPLICATION

This application is based upon and claims the benefit of priority from Japanese Patent Application No. 2021-189389, filed on Nov. 22, 2021; the entire contents of which are incorporated herein by reference.

### FIELD

Embodiments relate to a magnet material and a permanent magnet.

### BACKGROUND

Permanent magnets are used in products in a wide range of fields including, for example, rotary electrical machines such as motors and power generators, electrical devices such as speakers and measuring devices, and vehicles such as automobiles and railroad cars. Recent years have seen demands for the downsizing, higher efficiency, and higher output of the above products, leading to requirements for high-performance permanent magnets that are high in magnetization and coercive force.

Rare-earth magnets such as Sm—Co-based magnets and Nd—Fe—B-based magnets are examples of a high-performance permanent magnet. In these magnets, Fe and Co contribute to an increase in saturation magnetization. Further, these magnets contain rare-earth elements such as Nd and Sm, and the behavior of 4f electrons of the rare-earth elements in a crystal field causes high magnetic anisotropy. This achieves high coercive force.

### BRIEF DESCRIPTION OF THE DRAWINGS

FIG. 1 is a schematic view illustrating a structure example of a metal structure.

FIG. 2 is a view illustrating the results of three-dimensional atom probe tomography (concentration distributions of Nb and B) in Example 1.

FIG. 3 is a view illustrating the results of three-dimensional atom probe tomography (concentration distributions of Nb and B) in Comparative Example 1.

FIG. 4 is a chart illustrating the concentration distributions of elements in a grain boundary phase of Example 1.

FIG. 5 is a chart illustrating the concentration distributions of elements in a grain boundary phase of Comparative Example 1.

### DETAILED DESCRIPTION

A magnet material of an embodiment is represented by

a composition formula 1: RₓNb_{y}B_{z}M_{100-x-y-z}

where R is at least one element selected from the group consisting of rare-earth elements, M is at least one element selected from the group consisting of Fe and Co, x is a number satisfying 4≤x≤10 atomic %, y is a number satisfying 0.1≤y≤8 atomic %, and z is a number satisfying 0.1≤z≤12 atomic %,

the magnet material including:

a main phase having a TbCu₇ crystal phase; and

a grain boundary phase, and

the magnet material satisfying a relation of n_{Nb2}/n_{Nb1}>5,

where n_{Nb1} is an average Nb concentration in the TbCu₇ crystal phase and n_{Nb2} is a maximum Nb concentration in the grain boundary phase.

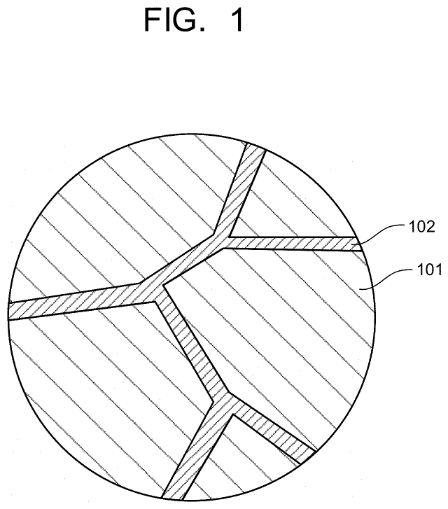

A magnet material of an embodiment contains a rare-earth element, an M element (M is at least one element selected from the group consisting of Fe and Co), niobium (Nb), and boron (B). The magnet material has a metal structure whose main phase is a TbCu₇ crystal phase containing the M element with high concentration. Increasing the M element concentration in the main phase enables an improvement in saturation magnetization, leading to an improvement in residual magnetization. The magnet material may be substantially composed of the TbCu₇ crystal phase, which is the main phase, and a grain boundary phase, but may include, for example, a microcrystalline phase and an impurity phase as other phases. The main phase is a phase having the highest volume occupancy ratio among crystal phases and amorphous phases in the magnet material. FIG. 1 is a schematic view illustrating a structure example of the metal structure. FIG. 1 illustrates crystal grains 101 having the TbCu₇ crystal phase and grain boundaries 102 present between the plurality of crystal grains 101 and having the grain boundary phase.

Adding Nb and B in addition to the rare-earth element and the M element enhances the amorphous formability and uniformizes the size of the main phase crystal grains obtained after heat treatment, achieving an increase in residual magnetization and coercive force. The magnet material, which is in powdery form, ribbon form, or the like, is molded, whereby a permanent magnet is manufactured. Examples of the permanent magnet include a bonded magnet that is molded using a binder such as a resin and a sintered magnet that is manufactured through the sintering of the powder. The applications of permanent magnets include rotary electrical machines such as motors and power generators. Recent years have seen increasing demands for the downsizing, higher speed, and higher efficiency of motors and power generators, leading to an increasing requirement for a heat resistance improvement of permanent magnets. For improving the heat resistance, the coercive force of permanent magnets and magnet materials need to be improved.

An example of an effective method for causing a magnet material having high magnetic anisotropy to exhibit high coercive force is to make crystal grains of the magnet material fine. An example of a method to make the crystal grains fine is to fabricate an amorphous ribbon using a liquid quenching method and thereafter apply appropriate heat treatment to cause the precipitation and growth of the crystal grains.

As a result of making the crystal grains of the main phase with high magnetic anisotropy fine, the individual crystal grains readily become single-domain grains, which reduces reverse domain generation and domain wall propagation, so that high coercive force is exhibited. Coercive force is low both in the case where the crystal grain size is too small and in the case where it is too large, and therefore, an average crystal grain size in the main phase is preferably not less than 1 nm nor more than 1000 nm (1 μm), more preferably not less than 1 nm nor more than 100 nm, and still more preferably not less than 10 nm nor more than 80 nm. Further, narrowing the grain size distribution in the main phase makes it possible to improve squareness in the demagnetization characteristic of the magnet material to improve the maximum energy product.

Another effective method for improving coercive force is to form a grain boundary phase between a crystal grain and a crystal grain to weaken magnetic coupling between the crystal grains. Weakening the magnetism of the grain boundary phase, ideally demagnetizing the grain boundary phase, increases the effect of reducing the reverse domain generation and the propagation, enabling an improvement in coercive force.

For weakening the magnetism of the grain boundary phase, it is important to increase the concentration of a nonmagnetic element (Nb or B) in the grain boundary phase. Heat treatment under an appropriate condition promotes its atom diffusion between the main phase and the grain boundary phase, making it possible for the grain boundary phase to have a higher Nb or B concentration than the Nb or B concentration in the main phase.

By satisfying a relation of n_{Nb2}/n_{Nb1}>5, where n_{Nb1} is an average Nb concentration in the TbCu₇ crystal phase which is the main phase and n_{Nb2} is the maximum Nb concentration in the grain boundary phase, it is possible to improve coercive force. The relation is more preferably n_{Nb2}/n_{Nb1}>10, and still more preferably n_{Nb2}/n_{Nb1}>20. The upper limit of n_{Nb2}/n_{Nb1} is not limited but is, for example, 500.

By satisfying a relation of n_{B2}/n_{B1}>5, where n_{B1} is an average B concentration in the TbCu₇ crystal phase and n_{B2} is the maximum B concentration in the grain boundary phase, it is possible to improve coercive force. The relation is more preferably n_{B2}/n_{B1}>7, and still more preferably n_{B2}/n_{B1}>10. The upper limit of n_{B2}/n_{B1} is not limited but is, for example, 500.

By satisfying a relation of n_{B2}/n_{B1}<0.5, where n_{R1} is an average R element concentration in the TbCu₇ crystal phase and n_{R2} is the minimum R element concentration in the grain boundary phase, it is possible to improve coercive force owing to the effect of promoting the atom diffusion of Nb and B between the main phase and the grain boundary phase, and so on. The relation between the average R element concentration in the main phase and the minimum R element concentration in the grain boundary is more preferably n_{R2}/n_{R1}<0.3, and still more preferably n_{R2}/n_{R1}<0.1.

For achieving high coercive force and high residual magnetization, the addition amounts of the rare-earth element, the M element, Nb, and B are preferably controlled. The magnet material of the embodiment is represented by, for example, a composition formula 1: RₓNb_{y}B_{z}M_{100-x-y-z}. The magnet material may contain inevitable impurities.

The R element is a rare-earth element and is an element capable of imparting high magnetic anisotropy and thus high coercive force to the magnet material. Specifically, the R element is at least one element selected from the group consisting of yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu), and is especially preferably Sm. For example, in the case where the R element is composed of a plurality of elements including Sm, by setting the Sm concentration to 50 atomic % or more of the total amount of the R element, it is possible to improve the magnetic properties, for example, the coercive force, of the magnet material.

The addition amount x of the R element is preferably a number satisfying, for example, 4≤x≤10 atomic %. x being less than 4 atomic % results in the prominent precipitation of an α-Fe phase to reduce coercive force. x being over 10 atomic % results in a relative reduction in the M element concentration in the main phase to reduce residual magnetization. The addition amount x of the R element is more preferably a number satisfying 5≤x≤8 atomic %, and still more preferably a number satisfying 5.5≤x≤7.5 atomic %.

Niobium (Nb) is an element effective for promoting amorphization. Further, appropriate heat treatment promotes its diffusion from the main phase to the grain boundary phase to weaken the magnetism of the grain boundary phase, thereby capable of increasing coercive force. The addition amount y of Nb is preferably a number satisfying, for example, 0.1≤y≤8 atomic %. y being less than 0.1 atomic % results in a difficulty in amorphization and a small effect of weakening the magnetism of the grain boundary phase, leading to low coercive force. y being over 8 atomic % results in low residual magnetization. The addition amount y of Nb is more preferably a number satisfying 1≤y≤6 atomic %, still more preferably a number satisfying 2≤y≤4 atomic %, and yet more preferably a number satisfying 2.2≤y≤4 atomic %.

50 atomic % or less of Nb may be replaced with at least one element selected from the group consisting of zirconium (Zr), hafnium (Hf), tantalum (Ta), molybdenum (Mo), and tungsten (W). Zr, Hf, Ta, Mo, and W are elements effective for promoting amorphization and stabilizing the crystal phases after the heat treatment.

The M element is at least one element selected from the group consisting of Fe and Co and is an element responsible for high saturation magnetization and high residual magnetization of the magnet material. Out of Fe and Co, Fe is higher in magnetization and thus 50 atomic % or more of the M element is preferably Fe. By the M element including Co, the Curie temperature of the magnet material increases, making it possible to prevent a reduction in saturation magnetization in high-temperature regions. Further, the M element including a small amount of Co achieves higher saturation magnetization than the M element including only Fe. On the other hand, increasing a ratio of Co may lower magnetic anisotropy. Appropriately controlling the ratio of Fe and Co achieves high saturation magnetization, a highly anisotropic magnetic field, and high Curie temperature at the same time. Let M in the composition formula 1 be represented by (Fe₁₋ₚCoₚ), a preferable value of p is 0.01≤p≤0.7, more preferably 0.05≤p≤0.5, and still more preferably 0.1≤p≤0.3. 20 atomic % or less of the M element may be replaced with at least one element selected from the group consisting of titanium (Ti), vanadium (V), chromium (Cr), manganese (Mn), nickel (Ni), copper (Cu), zinc (Zn), aluminum (Al), silicon (Si), and gallium (Ga). The above elements contribute to, for example, the stability improvement and grain size control of the main phase and the composition and thickness control of the grain boundary phase to have an effect of increasing coercive force and residual magnetization.

Boron (B) is an element effective for promoting amorphization. Appropriately controlling the addition amount z of B makes it possible to obtain an amorphous ribbon by a method with high industrial productivity such as a single-roll quenching method. Further, B enters the grain boundary phase to weaken the magnetism of the grain boundary phase, thereby capable of increasing coercive force. The addition amount z of B is preferably a number satisfying, for example, 0.1≤z≤12 atomic %, more preferably a number satisfying 1≤z≤10 atomic %, and still more preferably a number satisfying 5≤z≤10 atomic %.

By setting the composition of a region where the Nb concentration is highest in the grain boundary phase to a range represented by a composition formula 2: Rₓ₁Nb_{y1}B_{z1}M_{100-x1-y1-z1}, where R is at least one element selected from the group consisting of rare-earth elements, M is at least one element selected from the group consisting of Fe and Co, x1 is a number satisfying x1≤6 atomic %, y1 is a number satisfying y1≥20 atomic %, and z1 is a number satisfying z1≥20 atomic %, it is possible to further increase coercive force. Further, making the grain boundary phase an amorphous phase achieves still higher coercive force.

The magnet material of the embodiment may further contain an A element. The A element is at least one element selected from the group consisting of nitrogen (N), carbon (C), hydrogen (H), and phosphorus (P). The A element enters mainly interstitial positions of the TbCu₇ phase to expand crystal lattice or change electronic structure, thereby capable of changing the Curie temperature, magnetic anisotropy, and saturation magnetization. The A element does not necessarily have to be added except for the inevitable impurities.

The magnet material of the embodiment may be a quenched alloy ribbon fabricated by a liquid quenching method (melt-spinning method) or may be a powdery one obtained through the milling of the quenched alloy ribbon. The powder may be fabricated by a gas atomization method or the like.

In the case where the magnet material of the embodiment is the quenched alloy ribbon, the ribbon preferably has an average thickness of not less than 10 μm nor more than 80 μm. If the ribbon is too thin, a ratio of a surface deterioration layer formed at the time of the quenching and at the time of the heat treatment increases to lower the magnetic properties, for example, residual magnetization. If the ribbon is too thick, cooling rate distribution is likely to occur in the ribbon to lower coercive force. The average thickness of the ribbon is preferably not less than 20 μm nor more than 60 μm, and more preferably not less than 30 μm nor more than 50 μm.

A value of the specific coercive force of the magnet material of the embodiment is not less than 500 kA/m nor more than 2500 kA/m. For increasing heat resistance, this value is more preferably not less than 600 kA/m nor more than 2500 kA/m, and still more preferably not less than 650 kA/m nor more than 2500 kA/m.

A value of the residual magnetization of the magnet material of the embodiment is not less than 60 Am²/kg nor more than 170 Am²/kg. The higher the residual magnetization, the more effective for the downsizing and so on of a motor or a power generator. The residual magnetization is preferably not less than 75 Am²/kg nor more than 170 Am²/kg, and more preferably not less than 90 Am²/kg nor more than 170 Am²/kg.

It is important for magnet materials to have both high coercive force and high residual magnetization. The magnet material of the embodiment achieves both a specific coercive force of 600 kA/m or more and a residual magnetization of 90 Am²/kg or more.

The composition of the magnet material is measured by, for example, high-frequency ICP-AES (Inductively Coupled Plasma-Atomic Emission Spectroscopy), SEM-EDX (Scanning Electron Microscope-Energy Dispersive X-ray Spectroscopy), TEM-EDX (Transmission Electron Microscope-Energy Dispersive X-ray Spectroscopy), STEM-EDX (Scanning Transmission Electron Microscope-Energy Dispersive X-ray Spectroscopy), or the like. To identify phases constituting the magnet material, X-ray diffraction is usable. Volume ratios of the phases are comprehensively determined using both observation with an electron microscope or an optical microscope and the X-ray diffraction or the like.

An average grain size of the main phase is found as follows. A given grain is selected from main phase crystal grains that are specified in a cross section of the magnet material using STEM-EDX, and the longest straight line A whose ends are in contact with other phases is drawn on the selected grain. Next, a straight line B that is perpendicular to the straight line A at the midpoint of the straight line A and whose ends are in contact with other phases is drawn. An average length of the straight line A and the straight line B is defined as the diameter D in the phase. D in one given phase or more is found in the above procedure. Such D is calculated in five fields of view per sample, and an average of D's is defined as the diameter (D) in the phase. As the cross section of the magnet material, a substantially middle cross section of a surface having the largest area in the sample is used.

The compositions of the main phase and the grain boundary phase can be measured by three-dimensional atom probe tomography. The three-dimensional atom probe tomography has atomic-level spatial resolution and high detection sensitivity in a minute region and thus is suitable for measuring element distribution in the crystal grain boundary.

An average thickness of the quenched alloy ribbon is found as follows, for instance. The thickness of a ribbon piece with a 10 mm length or more is measured using a micrometer. The thickness measurement is conducted for ten ribbon pieces or more and an average value of the measured values excluding the maximum value and the minimum value is found, whereby the average thickness of the ribbon is calculated.

The magnetic properties such as the coercive force and the magnetization of the magnet material are calculated using, for example, a VSM (Vibrating Sample Magnetometer).

Next, an example of a method of manufacturing the magnet material of the embodiment will be described. First, an alloy containing predetermined elements necessary for the magnet material is manufactured. The alloy can be manufactured using, for example, an arc melting method, a high-frequency melting method, a mold casting method, a mechanical alloying method, a mechanical grinding method, a gas atomization method, a reduction diffusion method, or the like.

The alloy is melted and quenched. Consequently, the alloy is amorphized. The molten alloy is cooled using, for example, a liquid quenching method (melt-spinning method). In the liquid quenching method, the alloy molten metal is jetted to a roll rotating at a high speed. The roll may be either of a single-roll type or of a twin-roll type and as its material, copper or the like is mainly used. By controlling the amount of the jetted molten metal and the peripheral speed of the rotating roll, it is possible to control the cooling rate of the molten metal. By controlling the composition and the cooling rate, it is possible to control the degree of the amorphization of the alloy. Further, in the case where the alloy has already been amorphized by the use of the gas atomization method or the like at the time of the above alloy fabrication, the quenching process need not be executed at this time.

The alloy or alloy ribbon that has been amorphized is heat-treated. This makes it possible to crystallize the main phase to form a metal structure including the main phase having microcrystals. For example, the heating is executed at a temperature of not lower than 500° C. not higher than 1000° C. for not shorter than 5 minutes nor longer than 300 hours under an inert atmosphere, for example, in Ar or in a vacuum.

Too low a temperature results in insufficient crystallization and insufficient uniformity, leading to low coercive force. Too high a temperature results in the generation of a heterophase caused by the decomposition or the like of the main phase, leading to low coercive force and low squareness. The heating temperature is preferably, for example, not lower than 520° C. nor higher than 800° C., more preferably not lower than 540° C. nor higher than 700° C., and still more preferably not lower than 550° C. nor higher than 650° C. Too short a heating time results in insufficient crystallization and insufficient uniformity, leading to low coercive force.

Too long a heating time results in the generation of a heterophase caused by the decomposition or the like of the main phase, leading to low coercive force and low squareness. The heating time is preferably not shorter than 15 minutes nor longer than 150 hours, more preferably not shorter than 30 minutes nor longer than 120 hours, still more preferably not shorter than 1 hour nor longer than 120 hours, and yet more preferably not shorter than 2 hours nor longer than 100 hours, and yet more preferably in a range of longer than 3 hours to 80 hours or shorter.

After the heating, the crystallized alloy or ribbon is cooled by a method such as furnace cooling, water quenching, gas quenching, or oil quenching.

The A element may be caused to enter the alloy. Before the process of causing the A element to enter the alloy, the alloy is preferably milled to powder. In the case where the A element is nitrogen, it is possible to cause the nitrogen to enter the alloy by nitriding the alloy by heating the alloy at a temperature of not lower than 200° C. nor higher than 700° C. for not shorter than 1 hour nor longer than 100 hours in an atmosphere of nitrogen gas, an ammonia gas, or the like with an air pressure of about not less than 0.1 atm nor more than 100 atm. In the case where the A element is carbon, it is possible to cause the carbon to enter the alloy by carbonizing the alloy by heating the alloy in a temperature range of not lower than 300° C. nor higher than 900° C. for not shorter than 1 hour nor longer than 100 hours in an atmosphere of an ethylene (C₂H₂), methane (CH₄), propane (C₃H₈), or carbon monoxide (CO) gas or a pyrolysis gas of methanol (CH₃OH), with an air pressure of about not less than 0.1 atm nor more than 100 atm. In the case where the A element is hydrogen, it is possible to cause the hydrogen to enter the alloy by hydrogenating the alloy by heating the alloy in a temperature range of not lower than 200° C. nor higher than 700° C. for not shorter than 1 hour nor longer than 100 hours in an atmosphere of a hydrogen gas, an ammonia gas, or the like with an air pressure of about not less than 0.1 atm nor more than 100 atm. In the case where the A element is phosphorus, it is possible to cause the phosphorus to enter the alloy by phosphorizing the alloy.

The magnet material is manufactured through the above-described process. Further, magnet powder is manufactured through the milling of the alloy or the ribbon. Further, a permanent magnet is manufactured using the magnet material or the magnet powder. The following is an example of a magnet manufacturing process.

A permanent magnet having a sintered compact can be formed through the pressure sintering of the magnet material. Examples of a method usable for the pressure sintering include a method of sintering the magnet material by heating after pressing it with a press molding machine, a method using discharge plasma sintering, a method using a hot press, and a method using hot working. For example, the magnet material is milled using a mill such as a jet mill or a ball mill and is subjected to magnetic field orientation pressing at a pressure of about one ton (1000 kg) in a magnetic field of about not less than 1 T nor more than 2 T, whereby a molded body is obtained. The obtained molded body is heated to be sintered in an inert gas atmosphere such as in Ar or in a vacuum, whereby the sintered compact is fabricated. By appropriately heat-treating the sintered compact in an inert gas atmosphere or the like, it is possible to manufacture the permanent magnet.

It is also possible to manufacture a bonded magnet by milling the magnet material and bonding the milled object using a binder and mixing it. As the binder, a thermosetting resin, a thermoplastic resin, a low-melting-point alloy, a rubber material, or the like is usable, for instance. As a molding method, a compression molding method or an injection molding method is usable, for instance.

The permanent magnet including the magnet material of the embodiment is usable in rotary electrical machines such as various motors and power generators. It is also usable as a stationary magnet and a variable magnet of a variable flux motor and a variable flux generator. The use of the permanent magnet in the rotary electrical machine brings about effects such as higher efficiency, downsizing, lower cost, and so on.

The aforesaid rotary electrical machine may be mounted in, for example, a railroad car (an example of a vehicle) used in railroad traffic. The use of a high-efficiency rotary electrical machine like the rotary electrical machine of the embodiment achieves the energy-saving traveling of the railroad vehicle.

The aforesaid rotary electrical machine may also be mounted in an automobile (another example of the vehicle) such as a hybrid car or an electric car. The aforesaid rotary electrical machine may also be mounted in, for example, an industrial apparatus (industrial motor), an air-conditioning apparatus (compressor motor for an air-conditioner or a water heater), an aerogenerator, or an elevator (winch).

### EXAMPLES

### Example 1, Comparative Example 1

Appropriate amounts of raw materials Sm, Fe, Co, Nb, and B were weighed, from which alloys were fabricated using a high-frequency melting method. Next, the alloys were melted and the obtained molten metals were quenched by a single-roll method, whereby quenched alloy ribbons were fabricated. The roll peripheral speed was set to 15 m/s. The result of X-ray diffraction showed that the obtained alloy ribbons presented a broad diffraction pattern, indicating the formation of an amorphous phase. Further, the alloy ribbons had a low specific coercive force of 1.2 kA/m, from which it was confirmed that the amorphous phase was formed in the entire alloy ribbons. Next, the alloy ribbons were heat-treated at a 625° C. temperature under an Ar atmosphere and thereafter were cooled to room temperature. The heat treatment time was nine hours in Example 1 and one hour in Comparative Example 1. The compositions of the alloy ribbons immediately after the quenching were evaluated using ICP-AES. Further, the coercive forces and residual magnetizations of the magnet materials in alloy ribbon form after the heat treatment were evaluated using a VSM. Table 1 shows the compositions of the magnet materials and the evaluation results of the specific coercive forces and the residual magnetizations of the magnet materials. “Fe_{bal}.” in the composition formulas indicates that the balance is Fe.

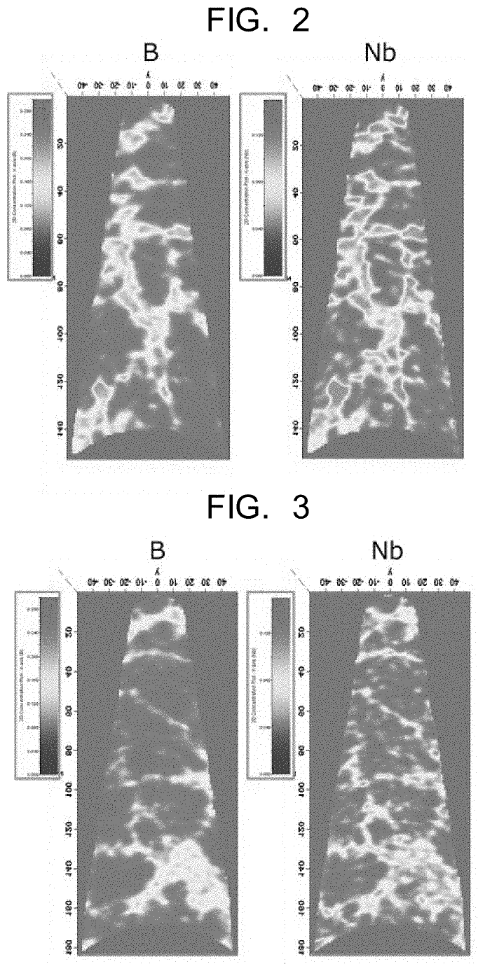

Regarding the alloy ribbons of Example 1 and Comparative Example 1, the compositions of a main phase and a grain boundary phase were analyzed using a three-dimensional atom probe. FIG. 2 illustrates an example of the results of the three-dimensional atom probe tomography (Nb and B concentration distributions) in Example 1. FIG. 3 illustrates an example of the results of the three-dimensional atom probe tomography (Nb and B concentration distributions) in Comparative Example 2.

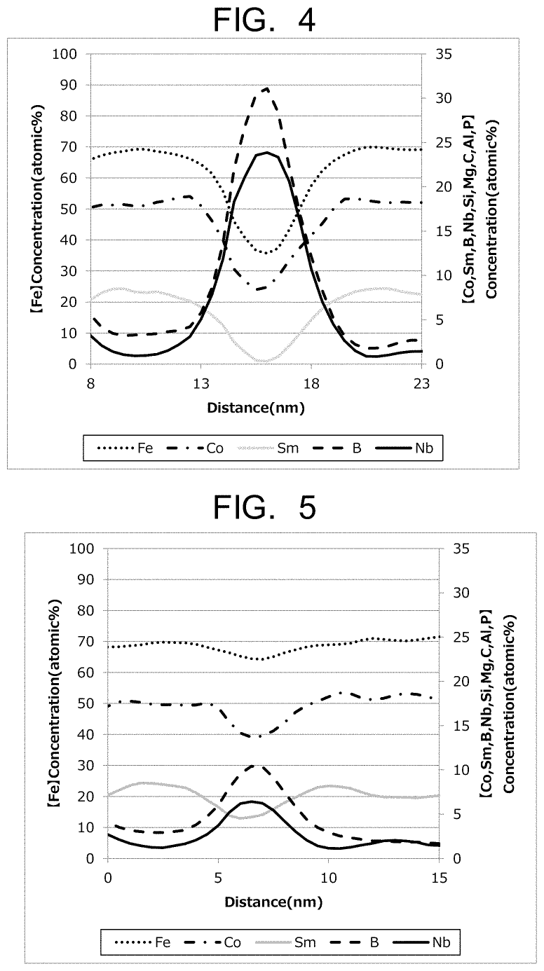

It is seen from FIG. 2 and FIG. 3 that the Nb and B concentrations are high in the grain boundary phase both in the samples of Example 1 and Comparative Example 1, but it is seen that this tendency is more prominent in the sample of Example 1 (heat treatment time: nine hours) than in the sample of Comparative Example 1 (heat treatment time: one hour). Here, with the focus on the grain boundary phase, concentration distributions were examined in more detail. FIG. 4 illustrates an example of the concentration distributions of the elements Sm, Fe, Co, Nb, and B in the grain boundary phase in Example 1. FIG. 5 illustrates an example of the concentration distributions of the elements Sm, Fe, Co, Nb, and B in the grain boundary phase in Comparative Example 1. As is obvious from FIG. 4 and FIG. 5, the grain boundary phase has higher Nb and B concentrations and contrarily has a lower R element (Sm) concentration in Example 1 than in Comparative Example 1.

An average Nb concentration (n_{Nb1}), an average B concentration (n_{B1}), and an average concentration of the R element (Sm) in a main phase (TbCu₇ phase) were determined as follows. First, an average value of analysis values at two places of the main phase across the grain boundary phase was found, the same analysis was conducted for three grain boundary phases, and an average value of the obtained analysis values was calculated as the average Nb concentration, the average B concentration, or the average R element (Sm) concentration in the main phase (TbCu₇ phase). Table 2 shows the calculated values. Further, the maximum Nb concentration (n_{Nb2}), the maximum B concentration (n_{B2}), and the minimum R element (Sm) concentration (n_{R2}) in the grain boundary phase were each found by similarly finding an average value of analysis values of the maximum values or the minimum values in the three grain boundaries. Table 2 shows the calculated values. From these values, the values of n_{Nb2}/n_{Nb1}, n_{B2}/n_{B1}, and n_{R2}/n_{R1} were calculated, which are shown in Table 2.

TABLE 1

| | | Heat treatment | Heat | Specific | Residual |
|---|---|---|---|---|---|
| | Composition of alloy ribbon | temperature | treatment | coercive | magnetization |
| | (atomic %) | (° C.) | time (h) | force (kA/m) | (Am²/kg) |
| Example 1 | Sm_{6.2}Fe_{bal.}Co_{14.6}Nb_{2.6}B_{7.3} | 625 | 9 | 655 | 92.4 |
| Comparative | Sm_{6.2}Fe_{bal.}Co_{14.6}Nb_{2.6}B_{7.3} | 625 | 1 | 479 | 95.4 |
| example 1 | | | | | |

TABLE 1

| | n_{Nb1} | n_{Nb2} | n_{B1} | n_{B2} | n_{R1} | n_{R2} | | | |
|---|---|---|---|---|---|---|---|---|---|
| | (atomic %) | (atomic %) | (atomic %) | (atomic %) | (atomic %) | (atomic %) | n_{Nb2}/n_{Nb1} | n_{B2}/n_{B1} | n_{R2}/n_{R1} |
| Example 1 | 0.9 | 22.4 | 2.5 | 29.2 | 8.4 | 0.3 | 24.9 | 11.7 | 0.04 |
| Comparative | 1.5 | 6.3 | 2.4 | 10.3 | 7.7 | 4.6 | 4.2 | 4.3 | 0.6 |
| example 1 | | | | | | | | | |

In the magnet material of Example 1, n_{Nb2}/n_{Nb1} reaches 24.9 and n_{B2}/n_{B1} reaches 11.7, showing that Nb and B are more prominently concentrated in the grain boundary phase than in the magnet material of Comparative Example 1. It is also seen that, in the magnet material of Example 1, the minimum R element (Sm) concentration n_{R2} in the grain boundary phase is 0.3 atomic % and thus is very low. The magnet material of Example 1 having such a grain boundary phase has a high residual magnetization of 92.4 Am²/kg and exhibits a high specific coercive force of 655 kA/m as is shown in Table 1.

### Examples 2 to 9, Comparative Examples 2, 3

From raw materials Sm, Fe, Co, Nb, and B, quenched alloy ribbons were fabricated as in Example 1. The obtained alloy ribbons were heat-treated in an Ar atmosphere under predetermined temperature and time conditions and thereafter were cooled to room temperature. The compositions of the alloy ribbons immediately after the quenching were evaluated using ICP-AES. Further, the coercive forces and the residual magnetizations of the magnet materials in alloy ribbon form after the heat treatment were evaluated using a VSM. Table 3 shows the compositions of the alloy ribbons and the evaluation results of the coercive forces and the residual magnetizations of the magnet materials.

The magnet materials of Example 2 to Example 9 all satisfy the relations of n_{Nb2}/n_{Nb1}>5, n_{B2}/n_{B1}>5, and n_{R2}/n_{R1}<0.5 and all have both a specific coercive force of 600 kA/m or more and a high residual magnetization of 89 Am²/kg or more. Further, in the magnet materials of Example 2 to Example 9, a region where the Nb concentration was highest in the grain boundary phase had the composition represented by the aforesaid composition formula 2: Rₓ₁Nb_{y1}B_{z1}M_{100-x1-y1-z1}.

On the other hand, neither of the magnet materials of Comparative Example 2 and Comparative Example 3 satisfied any of the relations of n_{Nb2}/n_{Nb1}>5, n_{B2}/n_{B1}>5, and n_{R2}/n_{R1}<0.5. Though fabricated through the heat treatment of the same quenched alloy ribbon as that of the magnet material of Example 1, the magnet materials of Comparative Example 2 and Comparative Example 3 did not have high coercive force because their heat treatment conditions were not appropriate. In Comparative Example 2, because the heat treatment temperature and the heat treatment time were not sufficient, atom diffusion between the main phase and the grain boundary phase was not sufficient, and accordingly, the effect of weakening the magnetism of the grain boundary phase was small and high specific coercive force could not be obtained. In Comparative Example 3, an α-Fe phase greatly precipitated because of too high a heat treatment temperature, resulting in very low specific coercive force. Further, in the magnet materials of Comparative Example 2 and Comparative Example 3, a region where the Nb concentration was highest in the grain boundary phase had a composition different from the composition represented by the aforesaid composition formula 2: Rₓ₁Nb_{y1}B_{z1}M_{100-x1-y1-z1}.

TABLE 3

| | | Heat treatment | Heat | Specific | Residual |
|---|---|---|---|---|---|
| | Composition of alloy ribbon | temperature | treatment | coercive | magnetization |
| | (atomic %) | (° C.) | time (h) | force (kA/m) | (Am²/kg) |
| Example 2 | Sm_{6.1}Fe_{bal.}Co_{15.0}Nb_{2.5}B_{7.3} | 625 | 7 | 616 | 93.9 |
| Example 3 | Sm_{6.1}Fe_{bal.}Co_{15.1}Nb_{2.5}B_{7.3} | 625 | 9 | 633 | 94.1 |
| Example 4 | Sm_{6.3}Fe_{bal.}Co_{14.7}Nb_{2.6}B_{7.3} | 625 | 9 | 619 | 92.4 |
| Example 5 | Sm_{6.2}Fe_{bal.}Co_{15.0}Nb_{2.6}B_{7.3} | 625 | 11 | 628 | 93.0 |
| Example 6 | Sm_{6.2}Fe_{bal.}Co_{15.0}Nb_{2.7}B_{8.3} | 610 | 29 | 633 | 93.8 |
| Example 7 | Sm_{6.2}Fe_{bal.}Co_{15.0}Nb_{2.7}B_{8.3} | 610 | 37 | 649 | 91.8 |
| Example 8 | Sm_{6.2}Fe_{bal.}Co_{15.0}Nb_{2.7}B_{8.3} | 630 | 7 | 604 | 89.0 |
| Example 9 | Sm_{6.2}Fe_{bal.}Co_{15.0}Nb_{2.7}B_{8.3} | 645 | 5 | 645 | 89.5 |
| Comparative | Sm_{6.2}Fe_{bal.}Co_{14.6}Nb_{2.6}B_{7.3} | 600 | 1 | 312 | 99.4 |
| example 2 | | | | | |
| Comparative | Sm_{6.2}Fe_{bal.}Co_{14.6}Nb_{2.6}B_{7.3} | 650 | 3 | 123 | 97.4 |
| example 3 | | | | | |

### Examples 10 to 13

From raw materials, an R element, Fe, Co, Nb, B, and so on, quenched alloy ribbons were fabricated as in Example 1. The obtained alloy ribbons were heat-treated in an Ar atmosphere under predetermined temperature and time conditions and thereafter were cooled to room temperature. The compositions of the alloy ribbons immediately after the quenching were evaluated using ICP-AES. Further, the coercive forces and residual magnetizations of the magnet materials in alloy ribbon form after the heat treatment were evaluated using a VSM. Table 4 shows the compositions of the alloy ribbons and the evaluation results of the coercive forces and the residual magnetizations of the magnet materials.

The magnet materials of Example 10 to Example 13 all satisfy the relations of n_{Nb2}/n_{Nb1}>5, n_{B2}/n_{B1}>5, and n_{R2}/n_{R1}<0.5 and all have both a specific coercive force of 600 kA/m or more and a high residual magnetization of 89 Am²/kg or more. Further, in the magnet materials of Example 10 to Example 13, a region where the Nb concentration was highest in the grain boundary phase had the composition represented by the aforesaid composition formula 2: Rₓ₁Nb_{y1}B_{z1}M_{100-x1-y1-z1}.

TABLE 4

| | | Heat treatment | Heat | Specific | Residual |
|---|---|---|---|---|---|
| | Composition of alloy ribbon | temperature | treatment | coercive | magnetization |
| | (atomic %) | (° C.) | time (h) | force (kA/m) | (Am²/kg) |
| Example 10 | (Sm_{0.98}La_{0.02})_{6.3}Fe_{bal.}Co_{15.6}Nb_{2.8}B_{8.5} | 625 | 9 | 640 | 92.9 |
| Example 11 | (Sm_{0.9}Y_{0.1})_{6.6}Fe_{bal.}Co_{16.0}Nb_{2.9}B_{8.3} | 625 | 9 | 615 | 94.5 |
| Example 12 | Sm_{6.4}Fe_{bal.}Co_{16.0}Si_{0.3}Nb_{2.8}B_{8.3} | 625 | 9 | 660 | 92.5 |
| Example 13 | Sm_{6.0}Fe_{bal.}Co_{16.0}Nb_{2.8}Zr_{0.6}B_{8.3} | 625 | 9 | 630 | 93.7 |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnet material represented by
a composition formula 1: RₓNb_{y}B_{z}M_{100-x-y-z}
where R is at least one element selected from the group consisting of rare-earth elements, M is at least one element selected from the group consisting of Fe and Co, x is a number satisfying 4≤x≤10 atomic %, y is a number satisfying 0.1≤y≤8 atomic %, and z is a number satisfying 0.1≤z≤12 atomic %,
the magnet material comprising:
a main phase having a TbCu₇ crystal phase; and
a grain boundary phase, and
the magnet material satisfying a relation of n_{Nb2}/n_{Nb1}>5,
where n_{Nb1} is an average Nb concentration in the TbCu₇ crystal phase and n_{Nb2} is a maximum Nb concentration in the grain boundary phase.

2. A magnet material represented by
a composition formula 1: RₓNb_{y}B_{z}M_{100-x-y-z}
where R is at least one element selected from the group consisting of rare-earth elements, M is at least one element selected from the group consisting of Fe and Co, x is a number satisfying 4≤x≤10 atomic %, y is a number satisfying 0.1≤y≤8 atomic %, and z is a number satisfying 0.1≤z≤12 atomic %,
the magnet material comprising:
a main phase having a TbCu₇ crystal phase; and
a grain boundary phase, and
the magnet material satisfying a relation of n_{B2}/n_{B1}>5,
where n_{B1} is an average B concentration in the TbCu₇ crystal phase and n_{B2} is a maximum B concentration in the grain boundary phase.

3. A magnet material represented by
a composition formula 1: RₓNb_{y}B_{z}M_{100-x-y-z}
where R is at least one element selected from the group consisting of rare-earth elements, M is at least one element selected from the group consisting of Fe and Co, x is a number satisfying 4≤x≤10 atomic %, y is a number satisfying 0.1≤y≤8 atomic %, and z is a number satisfying 0.1≤z≤12 atomic %,
the magnet material comprising:
a main phase having a TbCu₇ crystal phase; and
a grain boundary phase, and
the magnet material satisfying a relation of n_{R2}/n_{R1}<0.5,
where n_{R1} is an average R element concentration in the TbCu₇ crystal phase and n_{R2} is a minimum R element concentration in the grain boundary phase.

4. The magnet material according to claim 3,
the magnet material satisfying a relation of n_{B2}/n_{B1}>5,
where n_{B1} is an average B concentration in the TbCu₇ crystal phase and n_{B2} is a maximum B concentration in the grain boundary phase.

5. The magnet material according to claim 2,
the magnet material satisfying a relation of n_{Nb2}/n_{Nb1}>5,
where n_{Nb1} is an average Nb concentration in the TbCu₇ crystal phase and n_{Nb2} is a maximum Nb concentration in the grain boundary phase.

6. A magnet material represented by
a composition formula 1: RₓNb_{y}B_{z}M_{100-x-y-z}
where R is at least one element selected from the group consisting of rare-earth elements, M is at least one element selected from the group consisting of Fe and Co, x is a number satisfying 4≤x≤10 atomic %, y is a number satisfying 0.1≤y≤8 atomic %, and z is a number satisfying 0.1≤z≤12 atomic %, and
the magnet material comprising:
a main phase having a TbCu₇ crystal phase; and
a grain boundary phase,
wherein a region where a Nb concentration is highest in the grain boundary phase is represented by
a composition formula 2: Rₓ₁Nb_{y1}B_{z1}M_{100-x1-y1-z1}
where R is at least one element selected from the group consisting of rare-earth elements, M is at least one element selected from the group consisting of Fe and Co, x1 is a number satisfying x1≤6 atomic %, y1 is a number satisfying y1≥20 atomic %, and z1 is a number satisfying z1≥20 atomic %.

7. The magnet material according to claim 1,
wherein 50 atomic % or more of the R element is Sm.

8. The magnet material according to claim 1,
wherein 50 atomic % or less of Nb is replaced with at least one element selected from the group consisting of Zr, Hf, Ta, Mo, and W.

9. The magnet material according to claim 1,
wherein 50 atomic % or more of the M element is Fe.

10. The magnet material according to claim 1,
wherein 20 atomic % or less of the M element is replaced with at least one element selected from the group consisting of Ti, V, Cr, Mn, Ni, Cu, Zn, Al, Si, and Ga.

11. The magnet material according to claim 1,
wherein y in the composition formula 1 is a number satisfying 2.2≤y≤8 atomic %.

12. The magnet material according to claim 1,
wherein the grain boundary phase is an amorphous phase.

13. The magnet material according to claim 1,
the magnet material having a specific coercive force of 600 kA/m or more.

14. The magnet material according to claim 1,
the magnet material having a residual magnetization of 90 Am²/kg or more.

15. A permanent magnet comprising:
the magnet material according to claim 1; and
a binder.

16. A permanent magnet comprising
a sintered compact of the magnet material according to claim 1.
